(19) United States
(12) Patent Application Publication
(10) Pub. No.: US 2026/0161761 A1
(43) Pub. Date: Jun. 11, 2026

(54) METHODS AND SYSTEMS FOR IDENTIFICATION AND AUTHENTICATION

(71) Applicant: Comcast Cable Communications, LLC, Philadelphia, PA (US)

(72) Inventors: Christopher Lehmann, Philadelphia, PA (US); Kevin Colflesh, Philadelphia, PA (US)

(21) Appl. No.: 18/973,917

(22) Filed: Dec. 9, 2024

(51) Int. Cl. G06F 21/32; G06F 3/01

(52) U.S. Cl. CPC G06F 21/32; G06F 3/017

(57) ABSTRACT

Methods, apparatuses, and systems are described for providing biometric identification and authentication. A user may provide one or more visual communications or a sequence of visual communications in order to enter a password to authenticate the user. Based on data associated with the visual communications or sequence of visual communications, at least one visual communication and/or at least one transitional movement may be determined that is a unique manner in which the user performs a visual communication and/or a transitional movement. The user may be identified based on the at least one visual communication and/or the at least one transitional movement. The one or more visual communications or the sequence of visual communications may be matched to an acceptable visual communication or sequence of visual communications. Based on the match and the identification of the user, the user may be authenticated.

### BACKGROUND

Conventional access control systems require two-factor authentication methods for verifying an individual's identity in order to grant access to a system. These systems typically require an individual to enter a password, where the system further requires the individual to provide an alternative means of verification in order to grant access to the system. Some systems allow users to provide a voice input for access to the system. However, sign language speakers and people with limited mobility can experience difficulty in voice print identification in order to create frictionless experiences. Conventional authentication methods that involve the use of sign language and/or gestures for authenticating a user are typically limited. These and other shortcomings are identified and addressed in the disclosure.

### SUMMARY

It is to be understood that both the following general description and the following detailed description are examples and explanatory only and are not restrictive. Methods, systems, and apparatuses for providing biometric identification and authentication are disclosed.

A user may provide one or more visual communications (e.g., sign language, gestures, etc.) or a sequence of visual communications in order to enter a password and identify the user in order to authenticate the user. Based on data associated with the visual communications or sequence of visual communications, at least one visual communication and/or at least one transitional movement may be determined that is a unique manner in which the user performs a visual communication and/or a transitional movement. The user may be identified based on the at least one visual communication and/or the at least one transitional movement (e.g., movements connecting successive visual communications or gestures). The one or more visual communications or the sequence of visual communications may be matched to a known, for comparison, or an acceptable visual communication or sequence of visual communications. Based on the match and the identification of the user, the user may be authenticated.

This summary is not intended to identify critical or essential features of the disclosure, but merely to summarize certain features and variations thereof. Other details and features will be described in the sections that follow.

### BRIEF DESCRIPTION OF THE DRAWINGS

The accompanying drawings, which are incorporated in and constitute a part of this specification, illustrate embodiments and together with the description, serve to explain the principles of the methods and systems:

FIG. 1 shows an example system for identifying and authenticating a user;

FIG. 2 shows an example scenario;

FIG. 3 shows an example scenario;

FIG. 4 shows an example scenario;

FIG. 5 shows an example machine learning system;

FIG. 6 shows a flowchart of an example machine learning method;

FIG. 7 shows a flowchart of an example method;

FIG. 8 shows a flowchart of an example method;

FIG. 9 shows a flowchart of an example method;

FIG. 10 shows a flowchart of an example method; and

FIG. 11 shows a block diagram of an example system and computing device.

### DETAILED DESCRIPTION

Before the present methods and systems are disclosed and described, it is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

The present methods and systems may be understood more readily by reference to the following detailed description of preferred embodiments and the examples included therein and to the Figures and their previous and following description.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, magnetic storage devices, memristors, Non-Volatile Random Access Memory (NVRAM), flash memory, or a combination thereof.

Throughout this application reference is made to block diagrams and flowcharts. It will be understood that each block of the block diagrams and flowcharts, and combinations of blocks in the block diagrams and flowcharts, respectively, may be implemented by processor-executable instructions. These processor-executable instructions may be loaded onto a general purpose computer, special purpose computer, or other programmable data processing apparatus to produce a machine, such that the processor-executable instructions which execute on the computer or other programmable data processing apparatus create a device for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

This detailed description may refer to a given entity performing some action. It should be understood that this language may in some cases mean that a system (e.g., a computer) owned and/or controlled by the given entity is actually performing the action.

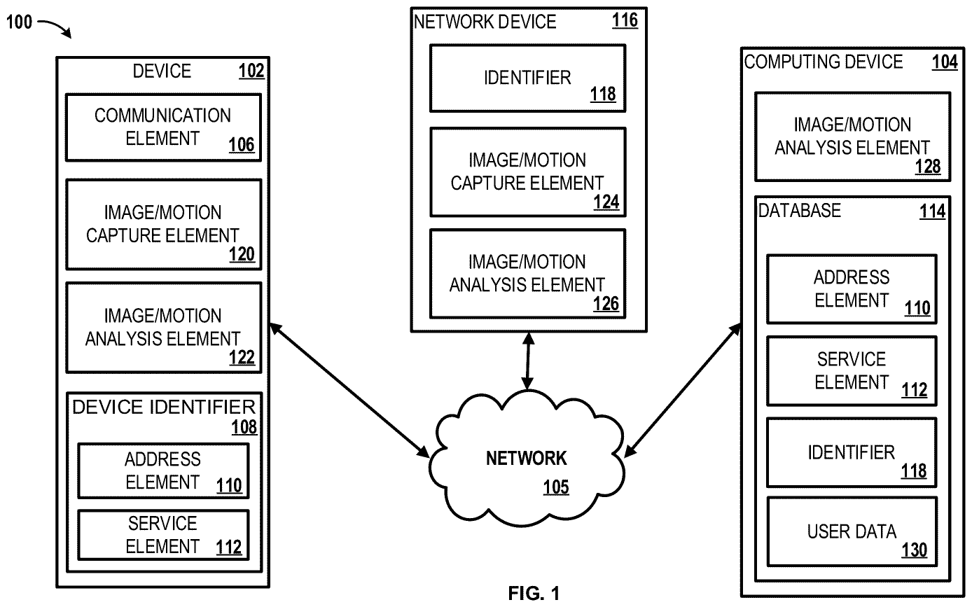

FIG. 1 shows an example system 100 for providing biometric identification and authentication. For example, the system 100 may be configured to identify and authentic a user based on one or more visual communications (e.g., sign language, hand signs, gestures, etc.) or a sequence of visual communications based on determining that at least one visual communication and/or at least one transitional movement is associated with a unique manner in which a user performs a visual communication and/or a transitional movement. The system 100 may comprise a user device 102, a network device 116, and/or a computing device 104. The user device 102 and/or the network device 116 may be in communication with the computing device 104 such as a centralized device or a server, for example. The computing device 104 may be disposed remotely relative to the user device 102 and the network device 116. As an example, the user device 102, the network device 116, and the computing device 104 may be in communication via a private and/or public network 105 such as the Internet or a local area network. Other forms of communications can be used such as wired and wireless telecommunication channels.

The user device 102 may comprise electronic devices such as a computer, a smartphone, a laptop, a tablet, a set top box, a display device, a printer, a network device, a communication terminal, or other device capable of communicating with the network device 116 and the computing device 104. As an example, the user device 102 may comprise a communication element 106 for offering an interface to a user to interact with the user device 102 and/or the computing device 104. The communication element 106 may be any interface for presenting and/or receiving information to/from the user, such as media content. As an example, the interface may be a communication interface such as a web browser (e.g., Internet Explorer®, Mozilla Firefox®, Google Chrome®, Safari®, or the like). Other software, hardware, and/or interfaces can be used to facilitate communication between the user and one or more of the user device 102 and the network device 116. As an example, the communication element 106 can request or query various files from a local source and/or a remote source. As an example, the communication element 106 can transmit data to a local or remote device such as the network device 116 or the computing device 104 via the network device 116.

The user device 102 may be associated with a user identifier or a device identifier 108. As an example, the device identifier 108 may be any identifier, token, character, string, or the like, for differentiating one user or user device (e.g., user device 102) from another user or user device. The device identifier 108 may identify a user or user device as belonging to a particular class of users or user devices. As an example, the device identifier 108 may comprise information relating to the user device such as a manufacturer, a model or type of device, a service provider associated with the user device 102, a state of the user device 102, a locator, and/or a label or classifier. Other information can be represented by the device identifiers 108.

The device identifier 108 may comprise address element 110 and service element 112. The address element 110 may comprise or make available an internet protocol address, a network address, a media access control (MAC) address, an Internet address, or the like. As an example, the address element 110 may be relied upon to establish a communication session between the user device 102 and the network device 116 or other devices and/or networks. As an example, the address element 110 may be used as an identifier or locator of the user device 102. The address element 110 may be persistent for a particular network.

The service element 112 may comprise identification of the service providers associated with the user device 102 and/or with the class of user device 102. The class of the user device 102 may be related to a type of device, a capability of a device, a type of service being offered, and/or a level of service (e.g., a business class, a service tier, a service package, etc.). As an example, the service element 112 may comprise information relating to or made available by a communication service provider (e.g., an Internet service provider) that is offering or enabling data flow such as communication services to the user device 102. As an example, the service element 112 may comprise information relating to a preferred service provider for one or more particular services relating to the user device 102. The address element 110 may be used to identify or retrieve data from the service element 112, or vice-versa. As an example, one or more of the address element 110 and the service element 112 may be stored remotely from the user device 102 and retrieved by one or more devices such as the user device 102 and the computing device 104. Other information may be represented by the service element 112.

The network device 116 may be in communication with a network, such as network 105. As an example, the network device 116 may be configured as a set top box. As an example, one or more of the network devices 116 may be configured to facilitate the connection of a device, such as the user device 102, to the network 105. As an example, the network device 116 may be configured as a wireless access points (WAPs) or router. The network device 116 may be configured to allow one or more wireless devices to connect to a wired and/or wireless network using Wi-Fi, Bluetooth®, Zigbee®, or any desired method or standard.

The network device 116 may be configured as a local area network (LAN). As an example, the network device 116 may comprise a dual band wireless access point. As an example, the network device 116 may be configured with a first service set identifier (SSID) (e.g., associated with a user network or a private network) to function as a local network for a particular user or users. As an example, the network device 116 may be configured with a second service set identifier (SSID) (e.g., associated with a public/community network or a hidden network) to function as a secondary network or redundant network for connected communication devices.

The network device 116 may comprise identifier 118. As an example, one or more identifiers may be or relate to an Internet Protocol (IP) Address IPV4/IPV6 or a media access control address (MAC address) or the like. As an example, the identifier 118 may be unique identifiers for facilitating communications on the physical network segment. The network device 116 may comprise an identifier 118 that is distinct. As an example, the identifier 118 may be associated with a physical location of the network device 116.

The computing device 104 may be a server, or a centralized device, for communicating with the network device 116, the user device 102, and the like within the network 105. In an example, the computing device 104 may communicate with the user device 102 for offering data and/or services. For example, the computing device 104 may offer services such as network (e.g., Internet) connectivity, network printing, media management (e.g., a media server), interference management, content services, streaming services, broadband services, or other network-related services.

The computing device 104 may allow the user device 102 to interact with remote resources such as data, devices, and files. As an example, the computing device 104 may be configured as (or disposed at) a central location (e.g., a headend, or a processing facility), which can receive content (e.g., data, input programming) from multiple sources. In an example, the computing device 104 may be a separate/remote device from the server for determining malicious activity within the communication network (e.g., network 105). The computing device 104 can combine the content from the multiple sources and can distribute the content to user (e.g., subscriber) locations via a distribution system.

The computing device 104 may be configured to manage the communication between the user device 102 and the network device 116 and a database 114 (e.g., storage system) for sending and receiving data therebetween. As an example, the database 114 may be configured to store a plurality of files, user identifiers or records, or other information. As an example, the user device 102 and/or the network device 116 may request and/or retrieve one or more files from the database 114. The database 114 may store information relating to the user device 102 such as the address element 110 and/or the service element 112. As an example, the computing device 104 may obtain the device identifier 108 and/or 118 from the user device 102 and/or the network device 116 and retrieve information from the database 114 such as the address element 110 and/or the service element 112. As a further example, the computing device 104 may obtain the address element 110 from the user device 102 and/or the network device 116 and may retrieve the service element 112 from the database 114, or vice versa. The database 114 may be integrated with the computing device 104 or some other device or system.

The device 102 and/or the network device 116 may comprise image/motion capture elements 120, 124, respectively. The image/motion capture elements 120, 124 may comprise one or more cameras (e.g., video cameras, mm Wave radar devices, Doppler radar devices, motion sensors, etc.) that may be used to capture one or more images (e.g., video, etc.) or motion capture data of a scene/environment within its field of view. For example, the image/motion capture elements 120, 124 may capture images, video, and/or motion data of a user performing one or more visual communications and/or sequences of visual communications.

The device 102, the network device 116, and/or the computing device 104 may comprise image/motion analysis elements 122, 126, 128, respectively. The image/motion analysis elements 122, 126, 128 may be configured to analyze one or more images or motion capture data (e.g., video, frames of video, radar capture data, etc.) determined/captured by the image/motion capture elements 120, 124 of the device 102 and/or the network device 116. As an example, the computing device 104 may receive the image/motion data of the image/motion capture elements 120, 124 and analyze the image/motion data via the image/motion analysis element 128. As an example, the image/motion analysis elements 122, 126, 128 may comprise a predictive model (e.g., machine learning model) configured to output an indication that a user is associated with one or more visual communications or an indication that a user is associated with one or more sequences of visual communications. The predictive model may be trained based on one or more visual communication datasets and one or more transition datasets. For example, the device 102, the network device 116, and/or the computing device 104 may receive one or more visual communication datasets associated with a unique manner in which each user of a plurality of users performs a plurality of visual communications and one or more transition datasets associated with a unique manner in which each user of the plurality of users performs one or more transitional movements between the plurality of visual communications. Each visual communication of the plurality of visual communications may comprise one or more of a hand sign or a gesture. As an example, one or more images and/or motions of the plurality of users performing the plurality of visual communications may be captured (e.g., via the image/motion capture element 120, 124). In addition, one or more images, and/or motions, of the plurality of users performing one or more sequences of the plurality of visual communications may be captured (e.g., via the image/motion capture element 120, 124). Each sequence of the one or more sequences of the plurality of visual communications may comprise one or more transitional movements between two or more visual communications of the corresponding sequence. As an example, the unique manner in which a particular user performs one or more visual communications and/or sequence of visual communications may be associated with one or more angles, orientations, and/or positioning of a user's hand(s), finger(s), and/or wrist(s) when the user performs the one or more visual communications and/or the one or more sequences of visual communications.

The image/motion analysis elements 122, 126, 128 may be configured to authenticate the user based on visual communications received via the image/motion capture elements 120, 124. In an example, the image/motion analysis elements 122, 126, 128 may authenticate the user based on a visual communication of one or more visual communications of a user. For example, data associated with one or more visual communications of a user may be received. For example, the image/motion capture elements 120, 124 may capture (e.g., via one or more images, videos, motion captures, and the like) a user performing one or more visual communications. The one or more visual communications may be associated with a sequence of visual communications comprising a password. It may be determined that at least one visual communication of the one or more visual communications is associated with a unique manner in which the particular user performs a visual communication based on the data associated with the one or more visual communications of the user. For example, the at least one visual communication of the one or more visual communications may be determined to be associated with a unique manner in which the particular user performs a visual communication based on an application of the predictive model to the data associated with the one or more visual communications of the user. The user may be authenticated based on the at least one visual communication. For example, the user may be authenticated based on matching the at least one visual communication with an acceptable visual communication.

In an example, the image/motion analysis elements 122, 126, 128 may authenticate the user based on a sequence of visual communications and a transitional movement. For example, data associated with a sequence of visual communications of a user may be received. For example, the image/motion capture elements 120, 124 may capture (e.g., via one or more images, videos, motion captures, and the like) a user performing a sequence of visual communications. The sequence of visual communications may comprise a password. At least one transitional movement between two or more visual communications of the sequence of visual communications may be determined based on the data associated with the sequence of visual communications of the user. For example, the at least one transitional movement between two or more visual communications of the sequence of visual communications may be determined based on an application of the predictive model to the data associated with the sequence of visual communications of the user. The user may be authenticated based on the sequence of visual communications and the at least one transitional movement. For example, the sequence of visual communications may be matched with an acceptable sequence of visual communications and the user may be identified based on the at least one transitional movement. The user may be authenticated based on the matching and based on the identification of the user. As an example, it may be determined that the at least one transitional movement is associated with a unique manner in which the particular user performs the sequence of visual communications. The user may be identified based on the determination that the at least one transitional movement is associated with the unique manner in which the particular user performs the sequence of visual communications.

In an example, the image/motion analysis element 122, 126, 128 may authenticate the user based on a sequence of visual communications and based on an identification of the user. For example, one or more visual communications of the sequence of visual communications and at least one transitional movement between two or more visual communications of the sequence of visual communications may be determined based on the data associated with the sequence of visual communications of the user. As an example, the one or more visual communications of the sequence of visual communications and the at least one transitional movement between the two or more visual communications of the sequence of visual communications may be determined based on an application of the predictive model to the data associated with the sequence of visual communications of the user. The user may be identified based on the one or more visual communications and the at least one transitional movement. For example, the user may be identified based on an application of the predictive model to data indicative of the one or more visual communications and the at least one transitional movement. For example, it may be determined that the one or more visual communications and the at least one transitional movement are associated with a unique manner in which the particular user performs the sequence of visual communications. The user may be identified based on the determination that the one or more visual communications and the at least one transitional movement are associated with the unique manner in which the particular user performs the sequence of visual communications. The user may be authenticated based on the sequence of visual communications and based on the identification of the user. For example, the user may be authenticated based on matching the sequence of visual communications with an acceptable sequence of visual communications and based on the identification of the user. In an example, based on the authentication of the user, the user may be granted access to one or more programs, applications, devices, systems, and the like.

The database 114 may be further configured to store the predictive model, the training data, and/or the user data 130 associated with user devices (e.g., user device 102) and/or the network device (e.g., network device 116). Any information can be stored in and retrieved from the database 114. As an example, the database 114 can be disposed remotely from the computing device 104 and accessed via a direct or an indirect connection. As an example, the database 114 can be integrated with the computing device 104 or some other device or system. The user data 130 may comprise user profile data and/or user password data for authenticating a user. For example, the user password data may comprise one or more visual communications and/or one or more sequences of visual communications associated with a password of the user for authenticating the user to access one or more programs, applications, device, systems, and the like associated with the user or the user's user profile.

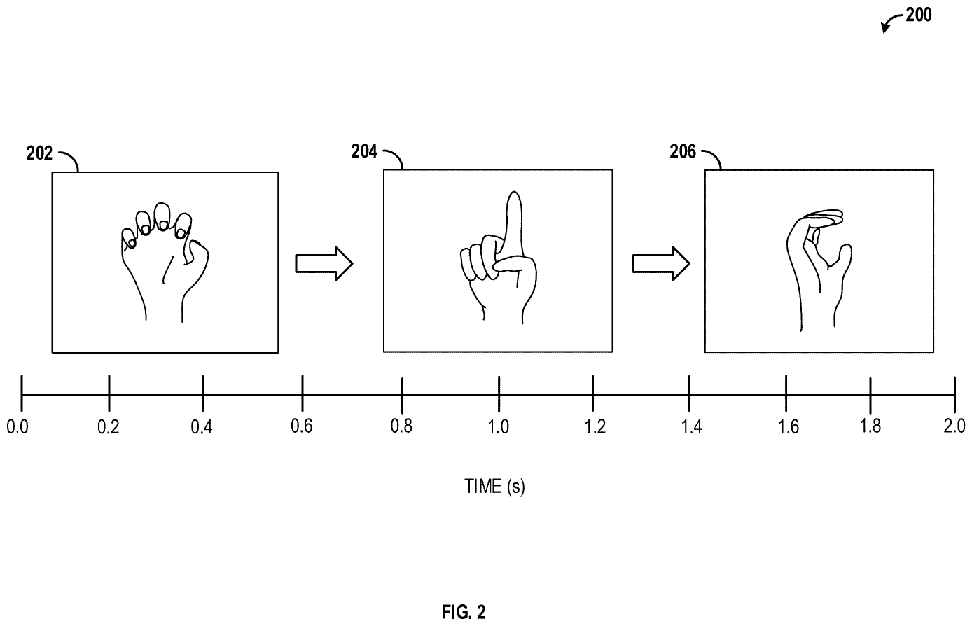

FIG. 2 shows an example scenario 200 wherein a user may provide a sequence of visual communications (e.g., sign language, hand signs, gestures, etc.). As an example, the user may provide a sequence of three hand signs. At 202, the user may provide a first hand sign associated with a first character, such as the letter “A.” At 204, the user may provide a second hand sign associated with a second character, such as the letter “D.” At 206, the user may provide a third hand sign associated with a third character, such as the letter “C.” The images, motion capture, and/or a video, of the sequence of hand signs may be analyzed to identify and authenticate the user. For example, it may be determined that at least one hand sign of the sequence of hand signs is associated with a unique manner in which the particular user performs the hand signs. In addition, the sequence may be analyzed to determine one or more transitional movements between each hand sign. It may be determined that at least one transitional movement of the one or more transitional movements is associated with a unique manner in which the particular user performs transitional movements between visual communications. In an example, the absence of a transitional movement may be associated with a unique manner in which the particular user performs a visual communication. The user may be identified based on the at least one hand sign, the at least one transitional movement, and/or the absence of a transitional movement. In addition, the sequence of hand signs may comprise a password. The sequence of hand signs may be compared to an acceptable sequence of hand signs (e.g., acceptable password). Based on the sequence of hand signs matching the acceptable sequence of hand signs and the identification of the user, the user may be authenticated. For example, based on the authentication of the user, the user may be granted access to one or more programs, applications, devices, systems, and the like. The scenario 200 shown in FIG. 2 is an example of a sequence of hand signs that may be analyzed in order to identify and authenticate a user. Any sequence of any hand sign, or gesture, may be captured and analyzed in order to identify and authenticate a user.

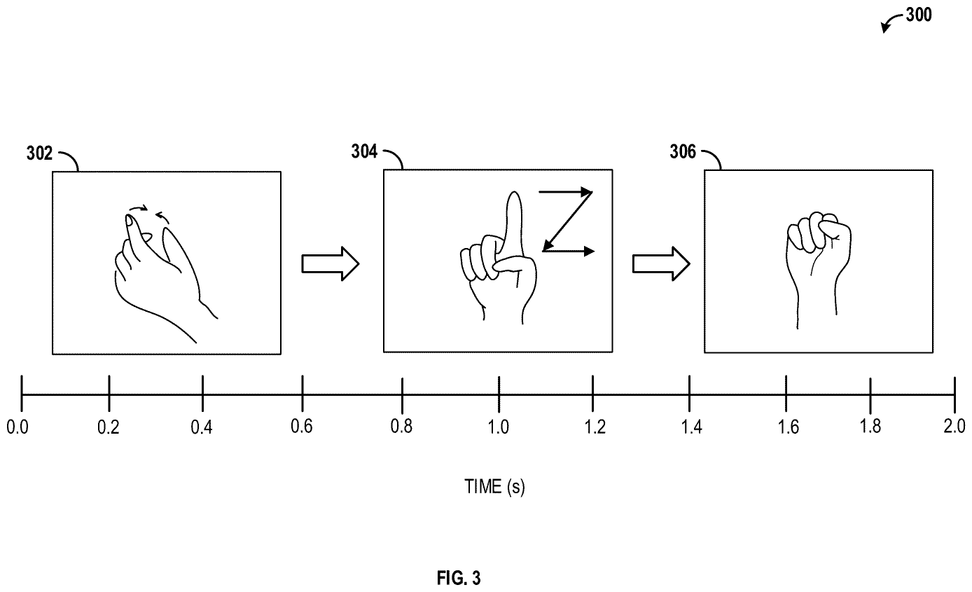

FIG. 3 shows an example scenario 300 wherein a user may provide a sequence of visual communications (e.g., sign language, hand signs, gestures, etc.). As an example, the user may provide a sequence of gestures and a hand sign. At 302, the user may provide a first gesture. At 304, the user may provide a second gesture. At 306, the user may provide a hand sign (e.g., associated with the letter “S”). The images, motion capture, and/or a video, of the sequence of visual communications may be analyzed to identify and authenticate the user. For example, it may be determined that at least one gesture or hand sign of the sequence of visual communications are associated with a unique manner in which the particular user performs a gesture and/or a hand sign. In addition, the sequence may be analyzed to determine one or more transitional movements between each visual communication (e.g., between the gestures and/or between the second gesture and the hand sign). It may be determined that at least one transitional movement of the one or more transitional movements is associated with a unique manner in which the particular user performs transitional movements between visual communications. The user may be identified based on the gestures, the hand sign, and/or the at least one transitional movement. In addition, the sequence of visual communications may comprise a password. The sequence of visual communications may be compared to an acceptable sequence of visual communications (e.g., acceptable password). Based on the sequence of visual communications matching the acceptable sequence of visual communications and the identification of the user, the user may be authenticated. For example, based on the authentication of the user, the user may be granted access to one or more programs, applications, devices, systems, and the like. The scenario 300 shown in FIG. 3 is an example of a sequence of hand signs that may be analyzed in order to identify and authenticate a user. Any sequence of any hand sign, or gesture, may be captured and analyzed in order to identify and authenticate a user.

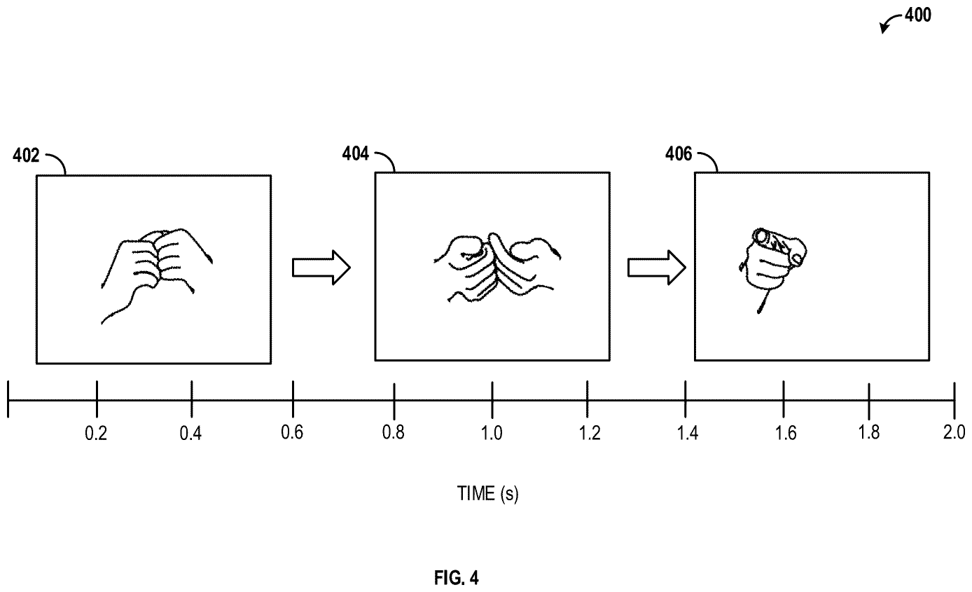

FIG. 4 shows an example scenario 400 wherein a user may provide a sequence of visual communications (e.g., sign language, hand signs, gestures, etc.). As an example, the user may provide sequence of two-handed gestures, such as a sequence of hand signs (e.g., gestures) associated with the word “small.” At 402, the user may provide a first gesture of the sequence. At 404, the user may provide a second gesture of the sequence. At 406, the user may provide a third gesture of the sequence. The images, motion capture, and/or a video, of the sequence of gestures may be analyzed to identify and authenticate the user. For example, it may be determined that at least one gesture of the sequence of gestures is associated with a unique manner in which the particular user performs the sequence of gestures representing the word “small.” In addition, the sequence may be analyzed to determine one or more transitional movements between each gesture. It may be determined that at least one transitional movement of the one or more transitional movements is associated with a unique manner in which the particular user performs transitional movements between gestures. The user may be identified based on the at least one gesture and/or the at least one transitional movement. In addition, the sequence of gestures associated with the word “small” may comprise a password. The sequence of gestures may be compared to an acceptable sequence of gestures (e.g., acceptable password associated with the word “small”). Based on the sequence of gestures matching the acceptable sequence of gestures and the identification of the user, the user may be authenticated. For example, based on the authentication of the user, the user may be granted access to one or more programs, applications, devices, systems, and the like. The scenario 400 shown in FIG. 4 is an example of a sequence of hand signs that may be analyzed in order to identify and authenticate a user. Any sequence of any hand sign, or gesture, may be captured and analyzed in order to identify and authenticate a user.

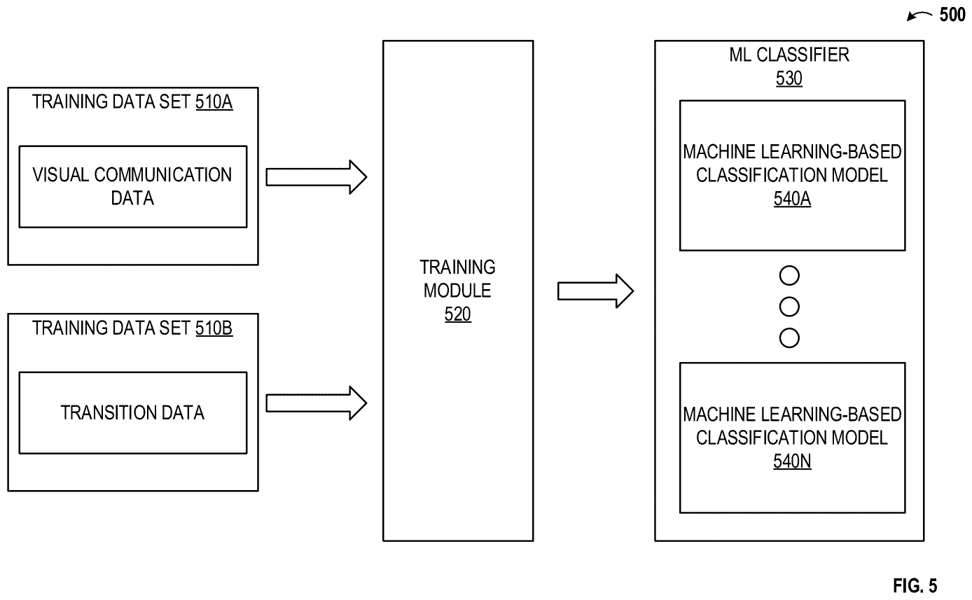

FIG. 5 shows a system 500 that may be configured to use machine learning techniques to train, based on an analysis of one or more training data sets 510A/510B by a training module 520, at least one machine learning-based classifier 530 that is configured to output an indication that a user is associated with one or more visual communications or an indication that a user is associated with one or more sequences of visual communications. As an example, training data set 510A (e.g., visual communication data) and the training data set 510B (e.g., transition data) may each comprise one or more data sets and/or baseline feature levels. As an example, one or more datasets associated with one or more groups of visual communication data and one or more groups of transition data may be determined based on the one or more training data sets 510A and the one or more training data sets 510B. As an example, the training data sets 510A/510B and/or the one or more datasets associated with the one or more groups of visual communication data and the one or more groups of transition data may comprise labeled baseline feature levels (e.g., baseline feature scores). The labels may comprise a plurality of predefined features associated with one or more characteristics associated with the visual communication data and the transition data. As an example, the one or more characteristics associated with the visual communication data and the transition data may be associated with a unique manner in which each user of a plurality of users performs a plurality of visual communications and/or a unique manner in which each user performs one or more transitional movements between the plurality of visual communications, such as one or more angles, orientations, and/or positioning of a user's hand(s), finger(s), and/or wrist(s) when the user performs one or more visual communications and/or one or more sequences of visual communications.

The training module 520 may train the machine learning-based classifier 530 by extracting a feature set from the visual communication data and the transition data (e.g., one or more training data sets and/or baseline feature levels) in the training data set 510 according to one or more feature selection techniques.

In an example, the training module 520 may extract a feature set from the training data sets 510A-510B in a variety of ways. The training module 520 may perform feature extraction multiple times, each time using a different feature-extraction technique. In an example, the feature sets generated using the different techniques may each be used to generate different machine learning-based classification models 540. As an example, the feature set with the highest quality metrics may be selected for use in training. The training module 520 may use the feature set(s) to build one or more machine learning-based classification models 540A-540N that are configured to indicate whether or not new data is associated with an indication that a user is associated with one or more visual communications or an indication that a user is associated with one or more sequences of visual communications. The visual communications may comprise one or more of a hand sign, sign language, a gesture, and the like.

In an example, the training data sets 510A/510B may be analyzed to determine one or more groups of visual communication data and transition data that have at least one feature that may be used to predict an indication that a user is associated with one or more visual communications or an indication that a user is associated with one or more sequences of visual communications. As an example, the at least one feature may comprise one or more characteristics of visual communication data and one or more characteristics of transition data. The characteristics may be associated with a unique manner in which each user of a plurality of users performs a plurality of visual communications and/or a unique manner in which each user performs one or more transitional movements between the plurality of visual communications, such as one or more angles, orientations, and/or positioning of a user's hand(s), finger(s), and/or wrist(s) when the user performs one or more visual communications and/or one or more sequences of visual communications. The one or more groups of visual communication data and transition data may be considered as features (or variables) in the machine learning context. The term “feature,” as used herein, may refer to any characteristic of a group of visual communication data and transition data that may be used to determine whether the group of visual communication data and transition data fall within one or more specific categories (e.g., angles/orientations/positions of a user's hand(s), finger(s), and/or wrist(s) when the user performs one or more visual communications and/or sequence of visual communications).

In an example, a feature selection technique may comprise one or more feature selection rules. The one or more feature selection rules may comprise a visual communication characteristic and transition data characteristic occurrence rule. The visual communication characteristic and transition data characteristic occurrence rule may comprise determining which visual communication characteristics and transition data characteristics or groups of visual communication characteristics and transition data characteristics in the training data sets 510A/510B occur over a threshold number of times and identifying those visual communication characteristics and transition data characteristics that satisfy the threshold as candidate features. For example, any visual communication characteristic and transition data characteristic or group of visual communication characteristics and transition data characteristics that appear greater than or equal to 50 times in the training data sets 510A/510B may be considered as candidate features. Any visual communication characteristic and transition data characteristic or group of visual communication characteristics and transition data characteristics appearing less than 50 times may be excluded from consideration as a feature.

In an example, the one or more feature selection rules may comprise a significance rule. The significance rule may comprise determining, from the baseline feature level (e.g., baseline feature score) data in the training data sets 510A/510B, visual communication characteristic data and transition characteristic data. The visual communication characteristic data may include data associated with a unique manner in which each user of a plurality of users performs a plurality of visual communications. The transition characteristic data may include data associated with a unique manner in which each user of the plurality of users performs one or more transitional movements between the plurality of visual communications. As the baseline feature level (e.g., baseline feature score) in the training data set 510A are labeled according to one or more visual communications (e.g., hand signs, sign language, gestures, etc.), the labels may be used to determine the visual communication characteristic data (e.g., unique manners in which a user performs the one or more visual communications such as one or more angles, orientations, and/or positioning of a user's hand(s), finger(s), and/or wrist(s) when the user performs the visual communications). As the baseline feature level (e.g., baseline feature score) in the training data set 510B are labeled according to one or more transitional movements between visual communications, the labels may be used to determine the transition characteristic data (e.g., unique manners in which a user performs the transitional movements between visual communications such as one or more angles, orientations, and/or positioning of a user's hand(s), finger(s), and/or wrist(s) when the user performs a sequence of visual communications).

In an example, a single feature selection rule may be applied to select features or multiple feature selection rules may be applied to select the features. For example, the feature selection rules may be applied in a cascading fashion, with the feature selection rules being applied in a specific order and applied to the results of the previous rule. For example, the visual communication characteristic and transition data characteristic occurrence rule may be applied to the training data sets 510A/510B to generate a first list of features. The significance rule may be applied to features in the first list of features to determine which features of the first list satisfy the significance rule in the training data sets 510A/510B and to generate a final list of candidate features.

The final list of candidate features may be analyzed according to additional feature selection techniques to determine one or more candidate feature signatures (e.g., groups of visual communication data and transition data that may be used to determine that a user is associated with one or more visual communications or that a user is associated with one or more sequences of visual communications). Any suitable computational technique may be used to identify the candidate feature signatures using any feature selection technique such as filter, wrapper, and/or embedded methods. In an example, one or more candidate feature signatures may be selected according to a filter method. Filter methods include, for example, Pearson's correlation, linear discriminant analysis, analysis of variance (ANOVA), chi-square, combinations thereof, and the like. The selection of features according to filter methods are independent of any machine learning algorithms. Instead, features may be selected on the basis of scores in various statistical tests for their correlation with the outcome variable (e.g., one or more expected indications of a user being associated with a visual communication and/or a sequence of visual communications).

In an example, one or more candidate feature signatures may be selected according to a wrapper method. A wrapper method may be configured to use a subset of features and train a machine learning model using the subset of features. Based on the inferences that are drawn from a previous model, features may be added and/or deleted from the subset. Wrapper methods include, for example, forward feature selection, backward feature elimination, recursive feature elimination, combinations thereof, and the like. As an example, forward feature selection may be used to identify one or more candidate feature signatures. Forward feature selection is an iterative method that begins with no feature in the machine learning model. In each iteration, the feature which best improves the model is added until an addition of a new variable does not improve the performance of the machine learning model. As an example, backward elimination may be used to identify one or more candidate feature signatures. Backward elimination is an iterative method that begins with all features in the machine learning model. In each iteration, the least significant feature is removed until no improvement is observed on removal of features. As an example, recursive feature elimination may be used to identify one or more candidate feature signatures. Recursive feature elimination is a greedy optimization algorithm which aims to find the best performing feature subset. Recursive feature elimination repeatedly creates models and keeps aside the best or the worst performing feature at each iteration. Recursive feature elimination constructs the next model with the features remaining until all the features are exhausted. Recursive feature elimination then ranks the features based on the order of their elimination.

In an example, one or more candidate feature signatures may be selected according to an embedded method. Embedded methods combine the qualities of filter and wrapper methods. Embedded methods include, for example, Least Absolute Shrinkage and Selection Operator (LASSO) and ridge regression which implement penalization functions to reduce overfitting. For example, LASSO regression performs L1 regularization which adds a penalty equivalent to the absolute value of the magnitude of coefficients and ridge regression performs L2 regularization which adds a penalty equivalent to the square of the magnitude of coefficients.

After the training module 520 has generated a feature set(s), the training module 520 may generate a machine learning-based classification model 540 based on the feature set(s). The machine learning-based classification model 540, may refer to a complex mathematical model for data classification that is generated using machine-learning techniques. In an example, this machine learning-based classifier may include a map of support vectors that represent boundary features. For example, boundary features may be selected from, and/or represent the highest-ranked features in, a feature set.

In an example, the training module 520 may use the feature sets extracted from the training data sets 510A/510B to build a machine learning-based classification model 540A-540N for each classification category (e.g., candidate network path prediction). In an example, the machine learning-based classification models 540A-540N may be combined into a single machine learning-based classification model 540. Similarly, the machine learning-based classifier 530 may represent a single classifier containing a single or a plurality of machine learning-based classification models 540 and/or multiple classifiers containing a single or a plurality of machine learning-based classification models 540.

The extracted features (e.g., one or more candidate features and/or candidate feature signatures derived from the final list of candidate features) may be combined in a classification model trained using a machine learning approach such as: generative predictive machine learning; discriminant analysis; decision tree; a nearest neighbor (NN) algorithm (e.g., k-NN models, replicator NN models, etc.); statistical algorithm (e.g., Bayesian networks, etc.); clustering algorithm (e.g., k-means, mean-shift, etc.); neural networks (e.g., reservoir networks, artificial neural networks, etc.); support vector machines (SVMs); logistic regression algorithms; linear regression algorithms; Markov models or chains; principal component analysis (PCA) (e.g., for linear models); multi-layer perceptron (MLP) ANNs (e.g., for non-linear models); replicating reservoir networks (e.g., for non-linear models, typically for time series); random forest classification; a combination thereof and/or the like. The resulting machine learning-based classifier 530 may comprise a decision rule or a mapping that uses the expression levels of the features in the candidate feature signature to output an indication that a user is associated with one or more visual communications or an indication that a user is associated with one or more sequences of visual communications.

The candidate feature signature and the machine learning-based classifier 530 may be used to output an indication that a user is associated with one or more visual communications or an indication that a user is associated with one or more sequences of visual communications. In an example, the result for each test includes a confidence level that corresponds to a likelihood or a probability that the corresponding test predicted that a user is associated with one or more visual communications and/or one or more sequences of visual communications. The confidence level may be a value between zero and one that represents a likelihood that the corresponding test is associated with an indication that a user is associated with one or more visual communications and/or one or more sequences of visual communications. In an example, when there are two or more statuses (e.g., two or more expected indications that a user is associated with one or more visual communications and/or one or more sequences of visual communications), the confidence level may correspond to a value p, which refers to a likelihood that a particular test is associated with a first status. In this case, the value 1-p may refer to a likelihood that the particular test is associated with a second status. In general, multiple confidence levels may be provided for each test and for each candidate feature signature when there are more than two statuses. A top performing candidate feature signature may be determined by comparing the result obtained for each test with known expected indications that a user is associated with one or more visual communications and/or one or more sequences of visual communications for each test. In general, the top performing candidate feature signature will have results that closely match the known indications that a user is associated with one or more visual communications and/or one or more sequences of visual communications.

The top performing candidate feature signature may be used to output an indication that a user is associated with one or more visual communications or an indication that a user is associated with one or more sequences of visual communications. For example, visual communication data and transition data and/or baseline feature data may be determined/received. The visual communication data and transition data and/or the baseline feature data may be provided to the machine learning-based classifier 530 which may, based on the top performing candidate feature signature, predict/determine an indication that a user is associated with one or more visual communications and/or one or more sequences of visual communications.

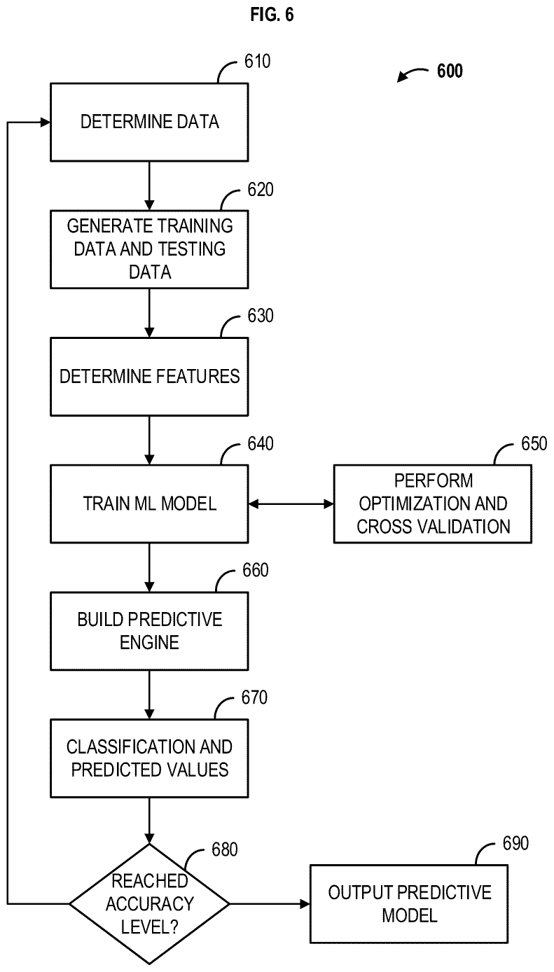

FIG. 6 shows a flowchart of an example training method 600 for generating the machine learning-based classifier 530 using the training module 520. The training module 520 may be implemented using supervised, unsupervised, and/or semi-supervised (e.g., reinforcement based) machine learning-based classification models 540. The method 600 shown in FIG. 6 is an example of a supervised learning method; variations of this example of training method are discussed below, however, other training methods may be analogously implemented to train unsupervised and/or semi-supervised machine learning models.

The training method 600 may determine (e.g., access, receive, retrieve, etc.) visual communication data and transition data at 610. The visual communication data and transition data may contain one or more datasets, wherein one or more datasets may be determined based on one or more groupings of the visual communication data and transition data. As an example, each dataset may include a labeled list of predetermined features. For example, each dataset may comprise labeled feature data.

The training method 600 may generate, at 620, a training data set and a testing data set. The training data set and the testing data set may be generated by randomly assigning labeled feature data of individual features from the visual communication data and the transition data to either the training data set or the testing data set. In an example, the assignment of the labeled feature data of individual features may not be completely random. In an example, only the labeled feature data for a specific grouping of visual communication data and transition data may be used to generate the training data set and the testing data set. In an example, a majority of the labeled feature data for the specific grouping of visual communication data and transition data may be used to generate the training data set. For example, 75% of the labeled feature data for the specific grouping of visual communication data and transition data may be used to generate the training data set and 25% may be used to generate the testing data set. In an example, only the labeled feature data for the specific grouping of visual communication data and transition data may be used to generate the training data set and the testing data set.

The training method 600 may determine (e.g., extract, select, etc.), at 630, one or more features that can be used by, for example, a classifier to differentiate among different classifications (e.g., different unique manners in which a user performs one or more visual communications and/or one or more transitional movements between the visual communications). The one or more features may comprise a group of visual communication datasets and transition datasets. In an example, the training method 600 may determine a set of features from the visual communication data and the transition data. In an example, a set of features may be determined from visual communication data and transition data from a different grouping than the grouping associated with the labeled feature data of the training data set and the testing data set. In other words, the visual communication data and the transition data from the different grouping may be used for feature determination, rather than for training a machine learning model. In an example, the training data set may be used in conjunction with the visual communication data and the transition data from the different grouping to determine the one or more features. The visual communication data and the transition data from the different grouping may be used to determine an initial set of features, which may be further reduced using the training data set.

The training method 600 may train one or more machine learning models using the one or more features at 640. As an example, the machine learning models may be trained using supervised learning. As an example, other machine learning techniques may be employed, including unsupervised learning and semi-supervised. The machine learning models trained at 640 may be selected based on different criteria depending on the problem to be solved and/or data available in the training data set. For example, machine learning classifiers can suffer from different degrees of bias. Accordingly, more than one machine learning model may be trained at 640, optimized, improved, and cross-validated at 650.

The training method 600 may select one or more machine learning models to build a predictive model at 660 (e.g., a machine learning classifier). The predictive model may be evaluated using the testing data set. The predictive model may analyze the testing data set and generate classification values and/or predicted values at 670. Classification and/or prediction values may be evaluated at 680 to determine whether such values have achieved a desired accuracy level. Performance of the predictive model may be evaluated in a number of ways based on a number of true positive, false positive, true negative, and/or false negative classifications of the plurality of data points indicated by the predictive model. For example, the false positives of the predictive model may refer to a number of times the predictive model incorrectly predicted a user was associated with a visual communication and/or a sequence of visual communications based on the visual communication data and the transition data. Conversely, the false negatives of the predictive model may refer to a number of times the machine learning model determined that a user was not associated with a visual communication and/or a sequence of visual communications when, in fact, the user was associated with the visual communication and/or the sequence of visual communications. True negatives and true positives may refer to a number of times the predictive model correctly classified the user was associated with a visual communication and/or a sequence of visual communications based on the visual communication data and the transition data. Related to these measurements are the concepts of recall and precision. Generally, recall refers to a ratio of true positives to a sum of true positives and false negatives, which quantifies a sensitivity of the predictive model. Similarly, precision refers to a ratio of true positives to a sum of true and false positives.

When a desired accuracy level is reached, the training phase ends and the predictive model may be output at 690; when the desired accuracy level is not reached, however, then a subsequent iteration of the training method 600 may be performed starting at 610 with variations such as, for example, considering a larger collection of visual communication data and transition data.

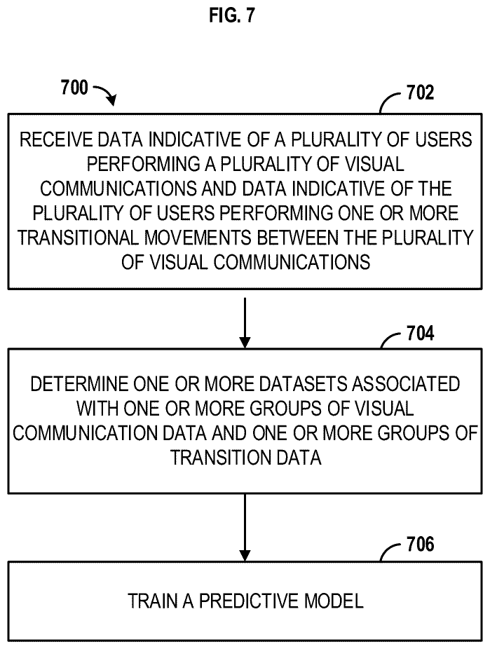

FIG. 7 shows a flowchart of an example method 700. Method 700 may be implemented, for example, by a computing device (e.g., device 102, network device 116, computing device 104, and the like, and/or any combinations thereof). At step 702, data indicative of a plurality of users performing a plurality of visual communications and data indicative of the plurality of users performing one or more transitional movements between the plurality of visual communications may be received. For example, a computing device (e.g., device 102, network device 116, computing device 104, and the like, and/or any combinations thereof) may the data indicative of the plurality of users performing the plurality of visual communications and the data indicative of the plurality of users performing the one or more transitional movements between the plurality of visual communications. In an example, one or more images, videos, and/or motion captures of the plurality of users performing the plurality of visual communications may be captured. The data indicative of the plurality of users performing the plurality of visual communications may be associated with the captured one or more images, videos, and/or motion captures of the plurality of users performing the plurality visual communications. Each visual communication of the plurality of visual communications may comprise one or more of a hand sign or a gesture. In an example, one or more images, videos, and/or motion captures of the plurality of users performing one or more sequences of the plurality of visual communications may be captured. The data indicative of the plurality of users performing the one or more transitional movements between the plurality of visual communications may be associated with the captured one or more images, videos, and/or motion captures of the plurality of users performing the one or more sequences of the plurality of visual communications. Each sequence of the one or more sequences of the plurality of visual communications may comprise one or more transitional movements between two or more visual communications of the corresponding sequence.

At step 704, one or more datasets associated with one or more groups of visual communication data and one or more groups of transition data may be determined based on the data indicative of the plurality of users performing the plurality of visual communications and the data indicative of the plurality of users performing the one or more transitional movements between the plurality of visual communications. For example, the computing device (e.g., device 102, network device 116, computing device 104, and the like, and/or any combinations thereof) may determine the one or more datasets associated with the one or more groups of visual communication data and the one or more groups of transition data based on the data indicative of the plurality of users performing the plurality of visual communications and the data indicative of the plurality of users performing the one or more transitional movements between the plurality of visual communications.

At step 708, a predictive model may be trained based on the one or more datasets. For example, the computing device (e.g., device 102, network device 116, computing device 104, and the like, and/or any combinations thereof) may cause the predictive model to be trained based on the one or more datasets. In an example, the predictive model may be configured to output an indication that a user is associated with one or more visual communications. In an example, the predictive model may be configured to output an indication that a user is associated with one or more sequences of visual communications.

As an example, data associated with one or more visual communications of a user may be received. It may be determined that at least one visual communication of the one or more visual communications is associated with a unique manner in which the user performs a visual communication based on an application of the predictive model to the data. The user may be authenticated based on the at least one visual communication. In an example, based on the authentication of the user, the user may be granted access to one or more programs, applications, devices, systems, and the like.

As an example, data associated with a sequence of visual communications of a user may be received. At least one transitional movement between two or more visual communications of the sequence of visual communications may be determined based on an application of the predictive model to the data. The user may be authenticated based on the sequence of visual communications and the at least one transitional movement.

As an example, data associated with a sequence of visual communications of a user may be received. One or more visual communications of the sequence of visual communications and at least one transitional movement between two or more visual communications of the sequence of visual communications may be determined based on an application of the predictive model to the data. The user may be identified based on the one or more visual communications and the at least one transitional movement. The user may be authenticated based on the sequence of visual communications and based on the identification of the user. In an example, the user may be authenticated based on matching the sequence of visual communications with an acceptable sequence of visual communications and based on the identification of the user. The sequence of visual communications may comprise a password.

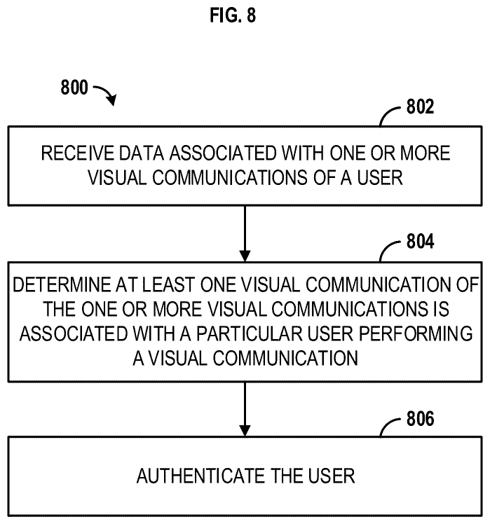

FIG. 8 shows a flowchart of an example method 800. Method 800 may be implemented, for example, by a computing device (e.g., device 102, network device 116, computing device 104, and the like, and/or any combinations thereof). At step 802, data associated with one or more visual communications of a user may be received. For example, a computing device (e.g., device 102, network device 116, computing device 104, and the like, and/or any combinations thereof) may receive the data associated with the one or more visual communications of the user. For example, one or more images, videos, and/or motion captures of the one or more visual communications of the user may be captured.

At step 804, it may be determined that at least one visual communication of the one or more visual communications is associated with a particular user performing a visual communication based on the data. For example, the computing device (e.g., device 102, network device 116, computing device 104, and the like, and/or any combinations thereof) may determine that the at least one visual communication of the one or more visual communications is associated with the particular user performing the visual communication based on the data. As an example, the it may be determine that the at least one visual communication is associated with a unique manner in which the user performs the visual communication based on the data. In an example, it may be determined that the at least one visual communication of the one or more visual communications is associated with the unique manner in which the user performs the visual communication based on an application of a predictive model to the data. The predictive model may be trained based on data indicative of a plurality of users performing a plurality of visual communications and data indicative of the plurality of users performing one or more transitional movements between the plurality of visual communications.

At step 806, the user may be authenticated based on the at least one visual communication. For example, the user may be authenticated by the computing device (e.g., device 102, network device 116, computing device 104, and the like, and/or any combinations thereof) based on the at least one visual communication. For example, the user may be authenticated based on matching the at least one visual communication with an acceptable visual communication. In an example, based on the authentication of the user, the user may be granted access to one or more programs, applications, devices, systems, and the like.

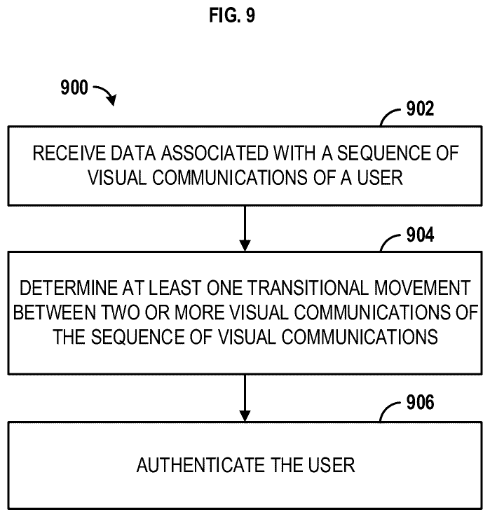

FIG. 9 shows a flowchart of an example method 900. Method 900 may be implemented, for example, by a computing device (e.g., device 102, network device 116, computing device 104, and the like, and/or any combinations thereof). At step 902, data associated with a sequence of visual communications of a user may be received. For example, a computing device (e.g., device 102, network device 116, computing device 104, and the like, and/or any combinations thereof) may receive the data associated with the sequence of visual communications of the user. For example, one or more images, videos, and/or motion captures of the sequence of visual communications of the user may be captured. The sequence of visual communications may comprise a password.

At step 904, at least one transitional movement between two or more visual communications of the sequence of visual communications may be determined based on the data. For example, the computing device (e.g., device 102, network device 116, computing device 104, and the like, and/or any combinations thereof) may determine the at least one transitional movement between the two or more visual communications of the sequence of visual communications based on the data. For example, the at least one transitional movement between the two or more visual communications of the sequence of visual communications may be determined based on an application of a predictive model to the data. The predictive model may be trained based on data indicative of a plurality of users performing a plurality of visual communications and data indicative of the plurality of users performing one or more transitional movements between the plurality of visual communications.

At step 906, the user may be authenticated based on the sequence of visual communications and the at least one transitional movement. For example, the user may be authenticated by the computing device (e.g., device 102, network device 116, computing device 104, and the like, and/or any combinations thereof) based on the sequence of visual communications and the at least one transitional movement. For example, the user may be authenticated based on matching the at least one visual communication with an acceptable visual communication. In an example, based on the authentication of the user, the user may be granted access to one or more programs, applications, devices, systems, and the like.

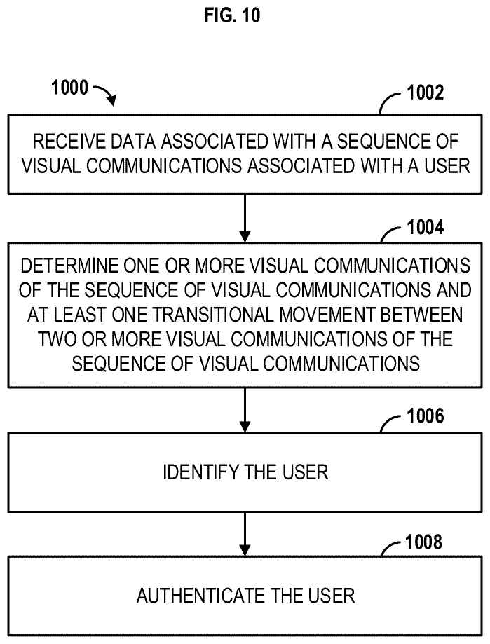

FIG. 10 shows a flowchart of an example method 1000. Method 1000 may be implemented, for example, by a computing device (e.g., device 102, network device 116, computing device 104, and the like, and/or any combinations thereof). At step 1002, data associated with a sequence of visual communications associated with a user may be received. For example, a computing device (e.g., device 102, network device 116, computing device 104, and the like, and/or any combinations thereof) may receive the data associated with the sequence of visual communications associated with the user. For example, one or more images, videos, and/or motion captures of the sequence of visual communications of the user may be captured. The sequence of visual communications may comprise a password.

At step 1004, one or more visual communications of the sequence of visual communications and at least one transitional movement between two or more visual communications of the sequence of visual communications may be determined based on the data. For example, the computing device (e.g., device 102, network device 116, computing device 104, and the like, and/or any combinations thereof) may determine the one or more visual communications of the sequence of visual communications and the at least one transitional movement between the two or more visual communications of the sequence of visual communications based on the data. For example, the one or more visual communications of the sequence of visual communications and the at least one transitional movement between the two or more visual communications of the sequence of visual communications may be determined based on an application of a predictive model to the data. The predictive model may be trained based on data indicative of a plurality of users performing a plurality of visual communications and data indicative of the plurality of users performing one or more transitional movements between the plurality of visual communications.

At step 1006, the user may be identified based on the one or more visual communications and the at least one transitional movement. For example, the user may be identified by the computing device (e.g., device 102, network device 116, computing device 104, and the like, and/or any combinations thereof) based on the one or more visual communications and the at least one transitional movement. In an example, the user may be identified based on an application of the predictive model to data indicative of the one or more visual communications and the at least one transitional movement. In an example, it may be determined that the one or more visual communications and the at least one transitional movement are associated with a unique manner in which the user performs the sequence of visual communications. The user may be identified based on the determination that the one or more visual communications and the at least one transitional movement are associated with the unique manner in which the user performs the sequence of visual communications.

At step 1008, the user may be authenticated based on the sequence of visual communications and based on the identification of the user. For example, the computing device (e.g., device 102, network device 116, computing device 104, and the like, and/or any combinations thereof) may authenticate the user based on the sequence of visual communications and based on the identification of the user. For example, the user may be authenticated based on matching the sequence of visual communications with an acceptable sequence of visual communications and based on the identification of the user. In an example, based on the authentication of the user, the user may be granted access to one or more programs, applications, devices, systems, and the like.

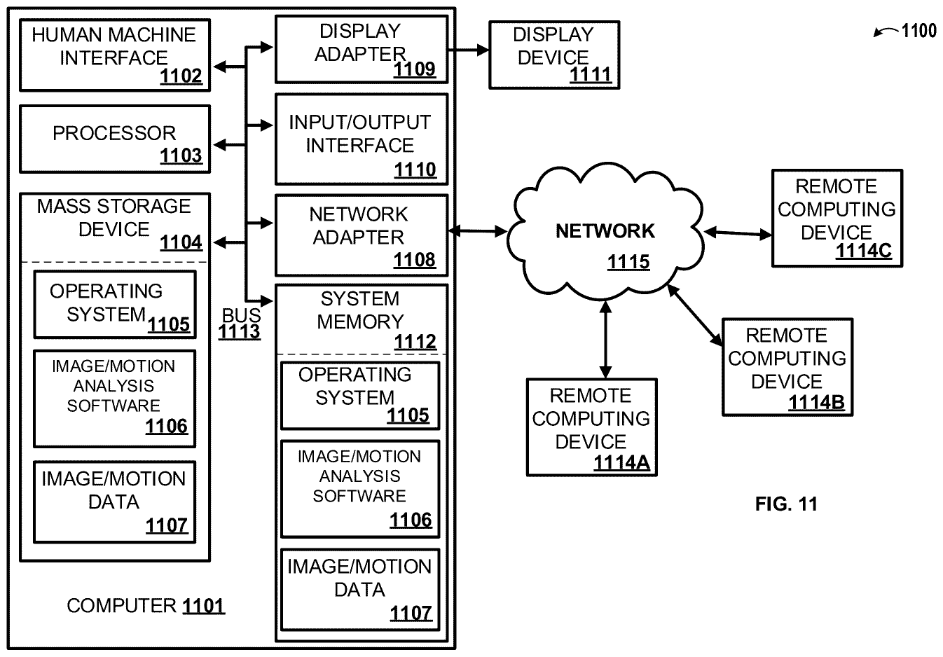

FIG. 11 shows a block diagram illustrating an example computing device. The methods and systems can be implemented on a computer 1101 as shown in FIG. 11 and described below. By way of example, user device 102, network device 116, and computing device 104 of FIG. 1 can be a computer 1101 as illustrated in FIG. 11. Similarly, the methods and systems disclosed can utilize one or more computers to perform one or more functions in one or more locations. FIG. 11 is a block diagram illustrating an exemplary operating environment 1100 for performing the disclosed methods. This exemplary operating environment 1100 is only an example of an operating environment and is not intended to suggest any limitation as to the scope of use or functionality of operating environment architecture. Neither should the operating environment 1100 be interpreted as having any dependency or requirement relating to any one or combination of components illustrated in the exemplary operating environment 1100.

The present methods and systems can be operational with numerous other general purpose or special purpose computing system environments or configurations. Examples of well-known computing systems, environments, and/or configurations that can be suitable for use with the systems and methods comprise, but are not limited to, personal computers, server computers, laptop devices, and multiprocessor systems. Additional examples comprise set top boxes, programmable consumer electronics, network PCs, minicomputers, mainframe computers, distributed computing environments that comprise any of the above systems or devices, and the like.

The processing of the disclosed methods and systems can be performed by software components. The disclosed systems and methods can be described in the general context of computer-executable instructions, such as program modules, being executed by one or more computers or other devices. Generally, program modules comprise computer code, routines, programs, objects, components, data structures, and/or the like that perform particular tasks or implement particular abstract data types. The disclosed methods can also be practiced in grid-based and distributed computing environments where tasks are performed by remote processing devices that are linked through a communications network. In a distributed computing environment, program modules can be located in local and/or remote computer storage media including memory storage devices.

Further, one skilled in the art will appreciate that the systems and methods disclosed herein can be implemented via a general-purpose computing device in the form of a computer 1101. The computer 1101 can comprise one or more components, such as one or more processors 1103, a system memory 1112, and a bus 1113 that couples various components of the computer 1101 including the one or more processors 1103 to the system memory 1112. In the case of multiple processors 1103, the system can utilize parallel computing.

The bus 1113 can comprise one or more of several possible types of bus structures, such as a memory bus, memory controller, a peripheral bus, an accelerated graphics port, and a processor or local bus using any of a variety of bus architectures. By way of example, such architectures can comprise an Industry Standard Architecture (ISA) bus, a Micro Channel Architecture (MCA) bus, an Enhanced ISA (EISA) bus, a Video Electronics Standards Association (VESA) local bus, an Accelerated Graphics Port (AGP) bus, and a Peripheral Component Interconnects (PCI), a PCI-Express bus, a Personal Computer Memory Card Industry Association (PCMCIA), Universal Serial Bus (USB) and the like. The bus 1113, and all buses specified in this description can also be implemented over a wired or wireless network connection and one or more of the components of the computer 1101, such as the one or more processors 1103, a mass storage device 1104, an operating system 1105, image/motion analysis software 1106, image/motion data 1107, a network adapter 1108, system memory 1112, an Input/Output Interface 1110, a display adapter 1109, a display device 1111, and a human machine interface 1102, can be contained within one or more remote computing devices 1114A-1114C at physically separate locations, connected through buses of this form, in effect implementing a fully distributed system.

The computer 1101 typically comprises a variety of computer readable media. Exemplary readable media can be any available media that is accessible by the computer 1101 and comprises, for example and not meant to be limiting, both volatile and non-volatile media, removable and non-removable media. The system memory 1112 can comprise computer readable media in the form of volatile memory, such as random access memory (RAM), and/or non-volatile memory, such as read only memory (ROM). The system memory 1112 typically can comprise data such as image/motion data 1107 and/or program modules such as operating system 1105 and image/motion analysis software 1106 that are accessible to and/or are operated on by the one or more processors 1103.

The computer 1101 can also comprise other removable/non-removable, volatile/non-volatile computer storage media. By way of example, the computer 1101 can comprise a mass storage device 1104 which can offer non-volatile storage of computer code, computer readable instructions, data structures, program modules, and other data for the computer 1101. For example, a mass storage device 1104 can be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Optionally, any number of program modules can be stored on the mass storage device 1104, including by way of example, an operating system 1105 and image/motion analysis software 1106. One or more of the operating system 1105 and image/motion analysis software 1106 (or some combination thereof) can comprise elements of the programming and the image/motion analysis software 1106. Image/motion data 1107 can also be stored on the mass storage device 1104. Image/motion data 1107 can be stored in any of one or more databases known in the art. Examples of such databases comprise, DB2®, Microsoft® Access, Microsoft® SQL Server, Oracle®, mySQL, PostgreSQL, NoSQL databases (i.e. MongoDB, Cassandra, ElasticSearch, CouchDB, etc.) and the like. The databases can be centralized or distributed across multiple locations within the network 1115.

The user can enter commands and information into the computer 1101 via an input device (not shown). Examples of such input devices comprise, but are not limited to, a keyboard, pointing device (e.g., a computer mouse, remote control), a microphone, a joystick, a scanner, tactile input devices such as gloves, and other body coverings, motion sensor, camera, radar sensor, and the like. These and other input devices can be connected to the one or more processors 1103 via a human machine interface 1102 that is coupled to the bus 1113, but can be connected by other interface and bus structures, such as a parallel port, game port, an IEEE 1394 Port (also known as a Firewire port), a serial port, network adapter 1108, and/or a universal serial bus (USB).

A display device 1111 can also be connected to the bus 1113 via an interface, such as a display adapter 1109. It is contemplated that the computer 1101 can have more than one display adapter 1109 and the computer 1101 can have more than one display device 1111. For example, a display device 1111 can be a monitor, an LCD (Liquid Crystal Display), light emitting diode (LED) display, television, smart lens, smart glass, and/or a projector. In addition to the display device 1111, other output peripheral devices can comprise components such as speakers (not shown) and a printer (not shown) which can be connected to the computer 1101 via Input/Output Interface 1110. Any step and/or result of the methods can be output in any form to an output device. Such output can be any form of visual representation, including, but not limited to, textual, graphical, animation, audio, tactile, and the like. The display 1111 and computer 1101 can be part of one device, or separate devices.

The computer 1101 can operate in a networked environment using logical connections to one or more remote computing devices 1114A, 1114B, and 1114C. By way of example, a remote computing device 1114A-1114C can be a personal computer, a computing station (e.g., a workstation), a portable computer (e.g., a laptop, a mobile phone, a tablet device), a smart device (e.g., a smartphone, a smart watch, an activity tracker, a smart apparel, a smart accessory), a security and/or monitoring device, a server, a router, a network computer, a peer device, an edge device or other common network node, and so on. Logical connections between the computer 1101 and a remote computing device 1114A-1114C can be made via a network 1115, such as a local area network (LAN) and/or a general wide area network (WAN). Such network connections can be through a network adapter 1108. A network adapter 1108 can be implemented in both wired and wireless environments. Such networking environments are conventional and commonplace in dwellings, offices, enterprise-wide computer networks, intranets, and the Internet.

For purposes of illustration, application programs and other executable program components such as the operating system 1105 are illustrated herein as discrete blocks, although it is recognized that such programs and components can reside at various times in different storage components of the computer 1101, and are executed by the one or more processors 1103 of the computer 1101. An implementation of image/motion analysis software 1106 can be stored on or transmitted across some form of computer readable media. Any of the disclosed methods can be performed by computer readable instructions embodied on computer readable media. Computer readable media can be any available media that can be accessed by a computer. By way of example and not meant to be limiting, computer readable media can comprise “computer storage media” and “communications media.” “Computer storage media” can comprise volatile and non-volatile, removable and non-removable media implemented in any methods or technology for storage of information such as computer readable instructions, data structures, program modules, or other data. Exemplary computer storage media can comprise RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

The methods and systems can employ artificial intelligence (AI) techniques such as machine learning (ML) and iterative learning. Examples of such techniques include, but are not limited to, expert systems, case based reasoning, Bayesian networks, behavior based AI, neural networks, fuzzy systems, evolutionary computation (e.g., a genetic algorithms), swarm intelligence (e.g., an ant algorithms), and hybrid intelligent systems (e.g., expert inference rules generated through a neural network or production rules from statistical learning).

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

It will be apparent to those skilled in the art that various modifications and variations can be made without departing from the scope or spirit. Other embodiments will be apparent to those skilled in the art from consideration of the specification and practice disclosed herein. It is intended that the specification and examples be considered as exemplary only, with a true scope and spirit being indicated by the following claims.

1. A method comprising:
receiving, by a computing device, data indicative of a plurality of users performing a plurality of visual communications and data indicative of the plurality of users performing one or more transitional movements between the plurality of visual communications;
determining, based on the data indicative of the plurality of users performing the plurality of visual communications and the data indicative of the plurality of users performing the one or more transitional movements between the plurality of visual communications, one or more datasets associated with one or more groups of visual communication data and one or more groups of transition data; and
training, based on the one or more datasets, a predictive model.

2. The method of claim 1, wherein each visual communication of the plurality of visual communications comprise one or more of a hand sign or a gesture.

3. The method of claim 1, wherein receiving the data indicative of the plurality of users performing the plurality of visual communications and the data indicative of the plurality of users performing the one or more transitional movements between the plurality of visual communications comprises capturing one or more images or motion captures of the plurality of users performing one or more of the plurality of visual communications or one or more sequences of the plurality of visual communications.

4. The method of claim 3, wherein each sequence of the one or more sequences of the plurality of visual communications comprise one or more transitional movements between two or more visual communications of the corresponding sequence.

5. The method of claim 1, wherein the predictive model is configured to output an indication that a particular user is associated with one or more visual communications or one or more sequences of visual communications.

6. The method of claim 1, further comprising:
receiving data associated with one or more visual communications of a user;
determining, based on an application of the predictive model to the data, at least one visual communication of the one or more visual communications is associated with a particular user performing a visual communication; and
authenticating, based on the at least one visual communication, the user.

7. The method of claim 1, further comprising:
receiving data associated with a sequence of visual communications of a user;
determining, based on an application of the predictive model to the data, at least one transitional movement between two or more visual communications of the sequence of visual communications; and
authenticating, based on the sequence of visual communications and the at least one transitional movement, the user.

8. The method of claim 1, further comprising:
receiving data associated with a sequence of visual communications of a user;
determining, based on an application of the predictive model to the data, one or more visual communications of the sequence of visual communications and at least one transitional movement between two or more visual communications of the sequence of visual communications;
identifying, based on the one or more visual communications and the at least one transitional movement, the user; and
authenticating, based on the sequence of visual communications and based on the identification of the user, the user.

9. A method comprising:
receiving, by a computing device, data associated with one or more visual communications of a user;
determining, based on the data, at least one visual communication of the one or more visual communications is associated with a particular user performing a visual communication; and
authenticating, based on the at least one visual communication, the user.

10. The method of claim 9, wherein the one or more visual communications are associated with a sequence of visual communications comprising a password.

11. The method of claim 9, wherein receiving the data associated with the one or more visual communications of the user comprises capturing one or more images or motion captures of the one or more visual communications of the user.

12. The method of claim 9, wherein determining, based on the data, the at least one visual communication of the one or more visual communications is associated with the particular user performing the visual communication comprises determining, based on an application of a predictive model to the data, the at least one visual communication of the one or more visual communications is associated with the particular user performing the visual communication.

13. The method of claim 12, wherein the predictive model is trained based on data indicative of a plurality of users performing a plurality of visual communications and data indicative of the plurality of users performing one or more transitional movements between the plurality of visual communications.

14. A method comprising:
receiving, by a computing device, data associated with a sequence of visual communications of a user;
determining, based on the data, at least one transitional movement between two or more visual communications of the sequence of visual communications; and
authenticating, based on the sequence of visual communications and the at least one transitional movement, the user.

15. The method of claim 14, wherein the sequence of visual communications comprises a password.

16. The method of claim 14, wherein receiving the data associated with the sequence of visual communications of the user comprises capturing one or more images or motion captures of the sequence of visual communications of the user.

17. The method of claim 14, wherein determining, based on the data, the at least one transitional movement between the two or more visual communications of the sequence of visual communications comprises determining, based on an application of a predictive model to the data, the at least one transitional movement between the two or more visual communications of the sequence of visual communications.

18. The method of claim 17, wherein the predictive model is trained based on data indicative of a plurality of users performing a plurality of visual communications and data indicative of the plurality of users performing one or more transitional movements between the plurality of visual communications.

19. The method of claim 14, wherein authenticating, based on the sequence of visual communications and the at least one transitional movement, the user comprises:
matching the sequence of visual communications with an acceptable sequence of visual communications;
identifying, based on the at least one transitional movement, the user; and
authenticating, based on the matching and based on the identification of the user, the user.

20. The method of claim 19, wherein identifying, based on the at least one transitional movement, the user comprises:
determining the at least one transitional movement is associated with a particular user performing the sequence of visual communications; and
identifying, based on the determination that the at least one transitional movement is associated with the particular user performing the sequence of visual communications, the user.
